(19) United States
(12) Patent Application Publication
(10) Pub. No.: US 2010/0028555 A1
(43) Pub. Date: Feb. 4, 2010

(54) RADIATION APPLIANCE, METHOD AND ARRANGEMENT FOR POWDER COATING OF TIMBER-DERIVED PRODUCTS

(76) Inventors: Gerhard Brendel, Auerbach (DE); Karl-Heinz Ullerich, Rednitzhembach (DE)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/373,452

(22) PCT Filed: Jun. 20, 2007
(86) PCT No.: PCT/EP2007/056160

§ 371 Date: Sep. 29, 2009

(30) Foreign Application Priority Data
Jul. 11, 2006 (DE) 10 2006 032 111.1

(51) Int. Cl. B05D 3/06; F26B 3/28; B05D 7/06

(52) U.S. Cl. 427/532; 392/407; 118/641

(57) ABSTRACT

A radiation appliance for irradiating surfaces of objects during powder coating, having energy radiators movably arranged on one carrier wherein at least one measuring temperature sensor that can measure the temperature of the object in at least one section of the surface of the object and a control unit are provided, wherein the control unit can record the measured temperature of the temperature sensor(s) and controls at least one energy radiator, which is assigned to the section of the surface whose temperature is being measured, and an arrangement and method for powder coating wooden objects, comprising a powder-coating station, a first radiation appliance, and a section for hardening or crosslinking the powder, wherein the first radiation appliance is arranged between powder-coating station and section and the second radiation appliance is arranged in the section, and the moisture content of the objects is set to 7 to 7.8 weight-percent water.

### FIELD OF THE INVENTION

The present invention relates to a method and an arrangement for powder coating, especially panel-shaped or disc-shaped wooden objects as well as to a corresponding radiation appliance therefor.

### BACKGROUND OF THE INVENTION

From WO 2006/061391 A2 is known a radiation appliance and a powder-application station and an arrangement for coating heat-sensitive materials and an associated method. The present invention relates to a further development of the devices and method described therein, such that the disclosure content of WO 2006/061391 A2 is incorporated by reference herein in its entirety.

From WO 2006/061391 are known a method and a corresponding device employing movable energy radiators, such as infrared radiators, to facilitate rapid warming or heating of surfaces and especially of MDF panels for powder coating that have been treated with a powder. Movement of the energy radiators is effected by oscillation, preferably on a circular path or part of a circular path. At the same time, the object to be coated with powder is moved past the energy radiators. This allows uniform powder coating of timber-derived materials without causing damage by heat exposure acting on the timber-derived products, especially at the core of the wood material.

Although the methods and devices described in WO 2006/061391 A2 yield very good results, further development of this new technology offers potential for further improvement with regard to the properties of the products made by means of the methods and devices and to a simplification of the work processes and the production of the devices.

### SUMMARY OF THE INVENTION

An object of the present invention to provide devices or methods that enable heat-sensitive materials and, especially timber-derived materials such as MDF (medium density fiber) elements, to be uniformly powder coated, with little load being placed on the material to be coated. At the same time, production of the coated products and of the necessary devices is to be simplified.

According to a first aspect of the present invention, it is proposed that at least one contactless temperature-measuring sensor be integrated in a radiation device for the irradiation of surfaces and, especially, for the rapid heating of surfaces of objects moved past the radiation device, such that a control device, also provided, can control at least one energy emitter assigned to the measured area via a surface temperature reading of the irradiated surface. In this way, it is possible to simply set the process parameters for different objects for coating or objects for coating with different powders, since the temperature readings in the simplest case of control after initial processing or irradiation of a specific object yield corresponding data which allow control over the radiation appliance or the energy radiators for a series of these objects. In addition to controlling the energy radiators, for example, with regard to switching them on or off when a temperature limit is exceeded, closed-loop control to a certain temperature or a temperature interval is possible.

It is also possible to exert direct closed-loop control over the energy radiators and, especially the performance of the energy radiators, during the irradiation process by arranging the temperature sensors, which can be formed by infrared sensors, such that direct measurement of the surface temperature during irradiation is possible. However, it is also possible for the purpose of simplifying the device to arrange the temperature sensors such that time-shifted open-loop or closed-loop control over the energy radiators is guaranteed. This is particularly advantageous in a radiation appliance having moving energy radiators, which, for example, oscillate in a circular path or move linearly during irradiation, as the movement of the energy radiators and in addition of the object to be irradiated would otherwise entail very high outlay for closed-loop control.

By closed-loop control in an aspect of the present case is thus also meant time-shifted control over the energy radiators on the basis of the determined temperature data and not just direct closed-loop control without major time delay or without local shifting of the arrangement of energy radiator and temperature sensor, which also is possible.

The control device can be formed as a closed-loop control unit, which automatically sets the temperature in at least one, preferably several, and especially all areas of the irradiated surface to a predetermined temperature or to a given temperature interval, with the temperature readings automatically being used for the purpose of open-loop control and thus of closed-loop control. Known closed-loop control techniques for this can be used.

The division of the surface for irradiation or the irradiated surface into imaginary or virtual areas is advantageous because, for the sake of simplicity, the temperature sensors are formed such that they can determine the temperature only in a localized area of the surface of the object for irradiation or the irradiated surface. Accordingly, the control unit to be set up such that, as well, for the measured area only, the energy radiators assigned to this area can be open-loop or closed-loop controlled. Thus, it is possible to correspondingly monitor, to provide open-loop control or to irradiate automatically under closed-loop control only individual, critical areas of the surface for irradiation or the irradiated surface. The entire surface for irradiation or the irradiated surface can be monitored by means of temperature sensors and to provide open-loop or closed-loop control of the energy radiators accordingly.

Accordingly, the surface for irradiation or the irradiated surface can be subdivided into a plurality of imaginary areas, with one or more temperature sensors being provided for each one.

The temperature sensors can accordingly be grouped together, such that an average temperature is formed from the various temperature sensors of a group for an area to be monitored.

In the same way, several energy radiators can also be grouped together, in which case the energy radiators of this group are uniformly provided with open-loop and/or closed-loop control by the control unit.

The imaginary areas of the irradiated surface or surface for irradiation can be arranged beside or above each other at right angles to a transport direction of the irradiated surface or surface for irradiation.

As already mentioned, the temperature sensors can be locally spaced apart from the energy radiators, with the possibility of a larger time-shift of the temperature measurement with respect to the irradiation with the corresponding energy radiator. This simplifies the outlay on an apparatus in a dynamic arrangement involving moved energy radiators and a moved object. To minimize the outlay for closed-loop control, the temperature sensors can be arranged equidistantly from their assigned energy radiators, such that the time shift for temperature measurement is the same for all temperature sensors. Accordingly, the temperature sensors can be arranged on a section of a circular path, an ellipse or an oval.

As the objects to be irradiated can be MDF panels, which are to be coated on two principal surfaces and the circumferential faces, the temperature sensors to be provided on both sides of the transport path for the objects to be irradiated, just as in the case of the energy radiators.

The temperature sensors can be infrared sensors, which can detect the radiation emitted from the surface. Since the emission values depend on the objects to be irradiated and, especially, the applied powder or its color, the control device and/or the temperature sensors can be formed such that temperature determination is adjusted automatically, for example by color matching. It is also possible for a database to be used for storing corresponding emission values for the objects to be irradiated and particularly the corresponding powders, such that the control device can use this information to make a corresponding adjustment to the evaluation or determination of the temperature values.

The control device can also infinitely variably adjust the radiant power of the energy radiators, such that the radiant power can be set specifically and precisely.

From another aspect of the present invention, the energy radiators can be arranged along an oval or a spiral, as this affords particularly homogeneous irradiation, especially of panel-like objects.

Irradiation can be in the near-infrared (NIR) range, wherein halogen infrared radiators particularly can be used.

From another aspect of the present invention, a method is proposed for powder coating wood materials, particularly MDF boards, in which initially powder is applied in a powder coating station and then the powder is heated or melted by a radiation device and finally cured in a hardening and crosslinking section. The moisture of the wooden objects to be coated can be adjusted to 7 to 7.8 weight-percent water, since this yields the best results for both powder application and the hardening and crosslinking, without damage to the wood material.

The hardening and crosslinking of the powder can occur after the first heating by a first inventive radiation appliance after the powder coating station, either in a forced air circulation oven and/or by means of a second radiation appliance, which preferably has UV radiators for UV-curing powders. Where a forced air circulation oven is used, an air speed of more than 5 m/s can be set.

The powder can be electrostatically applied, wherein the use of a small leakage current in the range 1 to 10 μA facilitates particularly homogeneous application of the powder.

During heat treatment of the powder by the first radiation appliance for the purpose of rapid heating, the surface temperature of the object or the powder can be greater than 110° C., especially greater than 140° C. and preferably in the range of 140° C. to 160° C. in order that rapid melting or rapid reaction of the powder may be guaranteed. The core temperature of the material to be coated should not exceed 100° C. and should preferably stay below 90° C.

During the hardening or crosslinking after treatment with the first radiation appliance, the surface temperature of the object should exceed 110° C. or be in the range from 115° C. to 150° C. and especially 140° C. to 150° C. and be kept constant for a certain period or be gradually lowered.

Especially, at any time, that is, also during hardening and crosslinking, the core temperature of the object should be kept below 100° C., preferably below 90° C. and especially in the range from 70° C. to 90° C.

In order that the above-described wood moisture content may be achieved, it is advantageous for the wood objects to be stored for a certain period of time at temperatures between 10° C. and 40° C. at a relative humidity of 30% to 50%, especially 35% to 45% and preferably 45% to 50%. To this end, a corresponding climate chamber with a corresponding arrangement for the coating of timber-derived products can be provided.

### BRIEF DESCRIPTION OF THE DRAWINGS

Further advantages, characteristics and features of the present invention are apparent from the following detailed description of an embodiment. The attached drawings show here in purely schematic form in

FIG. 1 is an inventive installation for the powder coating of MDF panels;

FIG. 2 is a side view of an inventive radiation appliance;

FIG. 3 is a cross-sectional view through the radiation appliance from FIG. 2 transverse to the transport plane;

FIGS. 4 (a) to (c) are side views of a supporting stand for temperature sensors;

FIG. 5 is a schematic illustration of the temperature sensors in an inventive radiation device; and

FIGS. 6 (a) and (c) are illustrations of the arrangement of the energy radiators.

### DETAILED DESCRIPTION OF THE PREFERRED EMBODIMENT

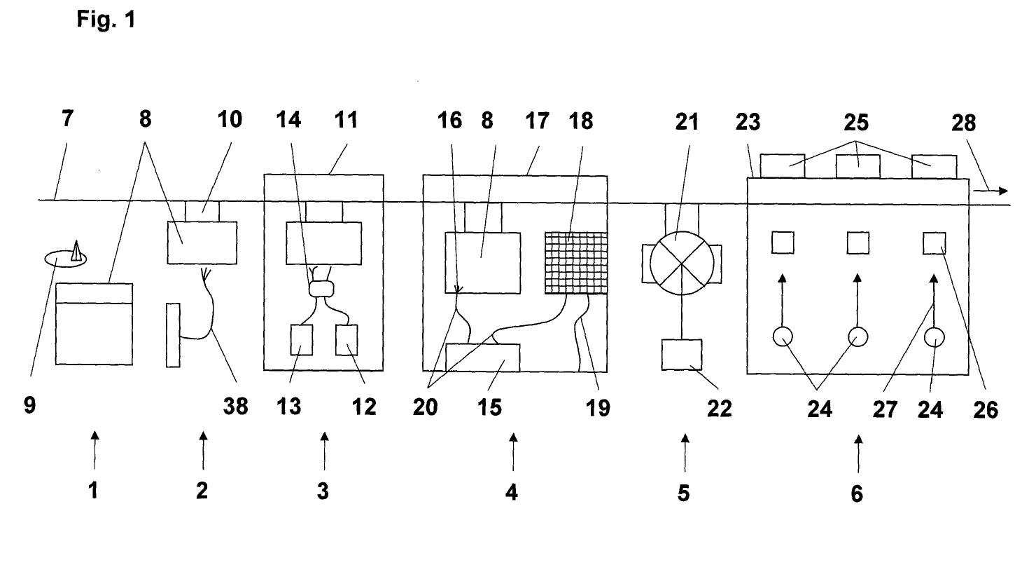

FIG. 1 shows a schematic illustration of the structure of an inventive installation for the powder coating of MDF panels 8 as it is used in the furniture industry.

In the embodiment, the installation has a total of six processing stations 1 to 6, through which the MDF panel 8 is transported by means of transport device 7. In the embodiment shown, the transport device 7 is realized by a rail arrangement in which are accommodated holders 10 from which the MDF panel 8 can be suspended.

In the first processing station 1, a grinding machine 9 processes the surfaces of the MDF panel 8 to produce a smooth clean surface.
Subsequently, the surface of the MDF panel is flame-treated in processing station 2 by means of a gas burner 38, shown schematically, in order that any wood fibers remaining after the grinding process may be removed and the surface compacted by exposure to the flames.
Alternatively or additionally, after or instead of processing station 2 and flaming, a plasma treatment installation (not shown) may be provided, the effect of the plasma on the surface also being to densify the surface.

In processing station 3 is shown a coating installation comprising a spray booth 11 and a spray device 14 which applies a primer to the surface of the MDF panel 8 by means of water-vapor-assisted coating. The primer serves to seal the surface gas-tight and to fill the pores in the surface of the MDF panel 8, as is described in the patent application by Patrick Oliver Ott for a method of pre-treating surfaces of wood and/or wood fiber composite blanks for subsequent powder or film coating.

A water-soluble primer, which may be a commercial primer, can be used since this, when used in conjunction with a water-vapor-assisted method, as described in patent application DE 10 2004 012 889, leads to particularly smooth and impervious surface layers. For this purpose, the coating installation of processing station 3 is provided with a water-vapor-generation device 12 in addition to the coating-supply device 13.

Furthermore, water-vapor-assisted coating offers the advantage that the MDF panel 8 treated with primer can be transferred immediately after coating to the next processing station in a continuous process, since the high temperature of the water vapor is conducive to very rapid drying. If required, a buffer station, not shown here, may be incorporated into the arrangement in order that a certain drying time may be realized for the MDF panels 8.

Powder application occurs in processing station 4, which also has a housing 17 and corresponding devices for electrostatic powder application, such as spray guns 16, powder hopper 15, feed lines 20 and the like.

In accordance with the invention, a diverting element 18 is additionally provided opposite each spray gun 16 in the powder-application station 4, the diverting element being earthed via the line 19 and serving to divert surplus charge and to smooth the pattern of the field lines on the object 8 to be coated in order that excessive powder coating may be avoided at the edges where field concentrations may occur: The current strength is selected so as to be very small, for example, in the range 1 to 10 μA.

In the embodiment shown in FIG. 1, the powder-application station 4 contains the spray gun 16 for each side of the MDF panel 8, with diverting elements 18 arranged opposite the spray guns 16. In the embodiment shown in FIG. 1, however, only one diverting element 18 is to be seen, as the other is obscured by the MDF panel 8. Furthermore, a second powder-application spray gun 16 is not shown, since it is obscured by the diverting element 18. Only supply line 20 can be seen.

As may also be seen in FIG. 1, the diverting element 18 in the embodiment shown is formed as a lattice structure, in which the lattice bars are formed as flat strips with a depth of a few centimeters (4 to 6 cm) and a thickness of about 0.5 to 1 cm. In addition to this embodiment of the diverting element 18, further embodiments are conceivable, such as vertical blinds, perforated sheets, slotted sheets, and the like. Since a certain amount of powder will be deposited on the diverting elements 18 over time, it is advantageous for a device to be provided with which the diverting elements 18 can be cleaned from time to time, for example, by corresponding vibration and the like.

The MDF board 8 coated with the powder is transferred by the transport device 7 to processing station 5 in which is provided an inventive radiation device 21 with short-wave infrared emitters, or near-infrared emitters, especially halogen emitters in order that the powder on the surface of the MDF board 8 may be melted by very rapid and brief heating.

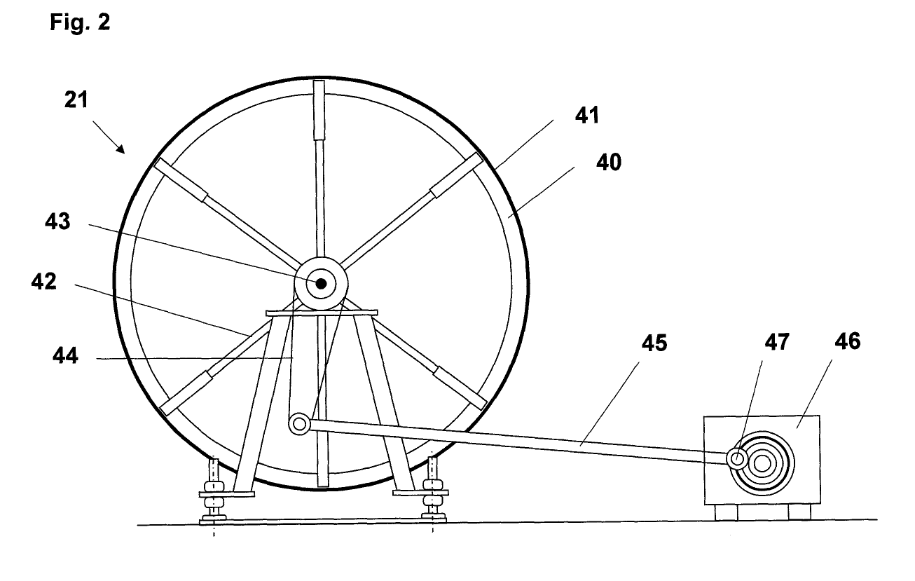

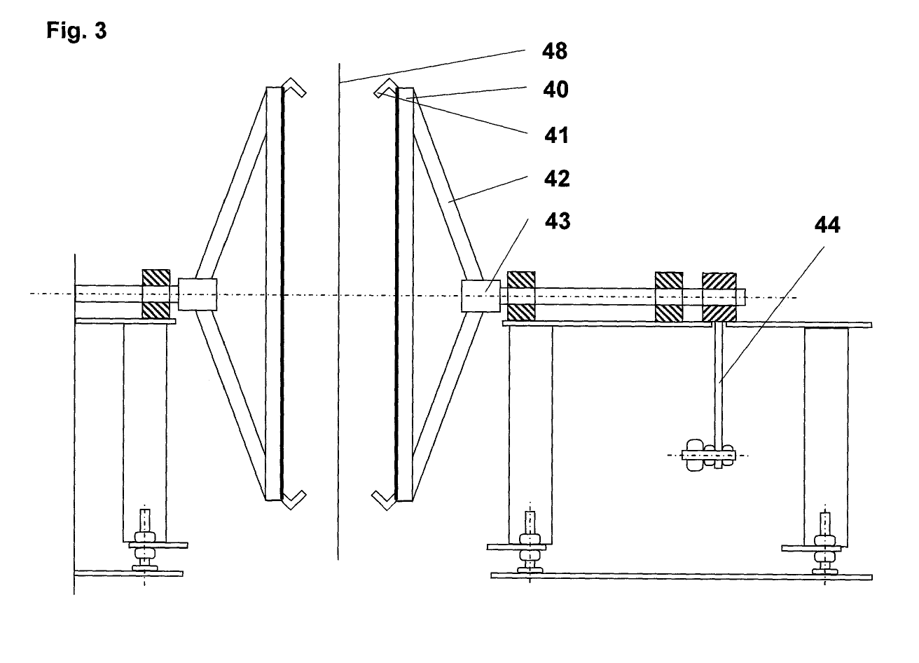

FIGS. 2 and 3 show the inventive radiation appliance and a section thereof in greater detail.

The radiation appliance 21 has, as is especially evident in FIG. 3, two opposing circular rings 40, at which the energy radiators 41 are arranged such that they can tilt or swivel about an axis of rotation parallel to a transport plane 48. The transport plane 48 for the MDF panels 8 runs between the rings 40 having the energy radiators 41.

The ring 40 is mounted to a rotating axis 43 via spokes 42 and is connected there to an eccentric pin 44 at which in turn a rod 45 is arranged. The other end of the rod 45 is also connected to an eccentric pin 47, which, for example, is arranged at an electric motor 46. As a result of this construction, with its two eccentric pins 44 and 47 connected by a rod 45, the rotary motion of the electric motor 46 is converted first into a back-and-forth movement of the rod 45 and, via eccentric pin 44, then into a swiveling movement of the ring 40. In this way, the energy radiators 41 in the ring plane 40 are moved back and forth about the axis 43 via a swiveling movement, such that their energy or heat is transferred to the MDF panel 8 over a curved area. Additionally, the rings 40 may be configured so as to be perpendicular to the transport plane 48.

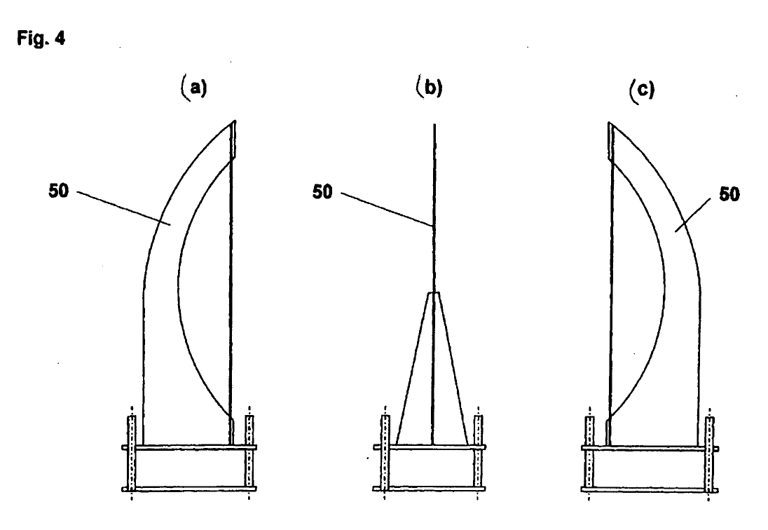

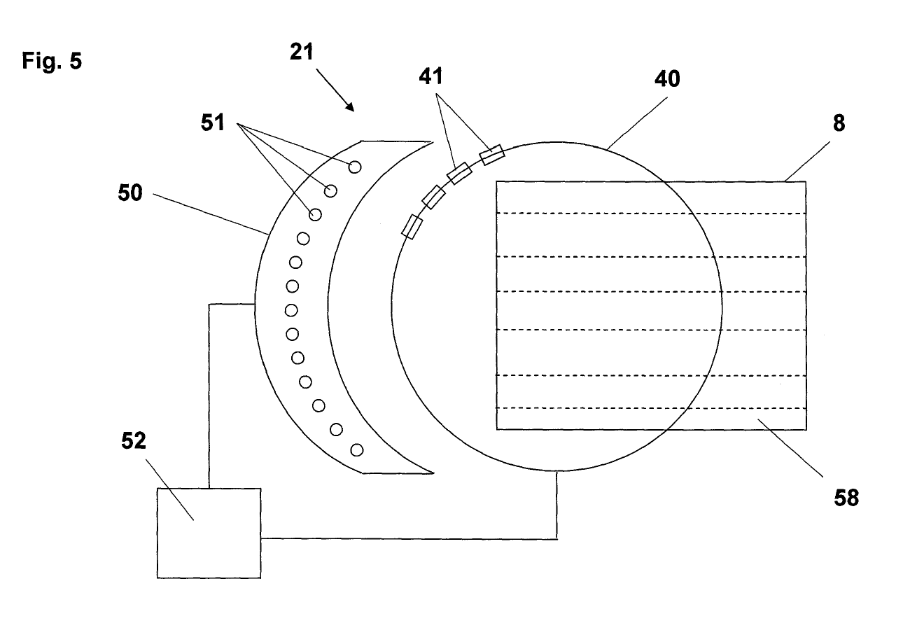

In accordance with an aspect of the invention, the radiation appliance 21 has an arrangement of temperature sensors that enable contact-less measurement of the surface temperature of the MDF panel 8. The holder is shown in FIGS. 4 (a) to (c) in various side views. Support stand 50 for the temperature sensor arrangement is a curved plate, which, in accordance with the illustration of FIG. 5 is arranged relative to the ring 40, more precisely with a support stand on each side of the transport plane 48.

The temperature sensors 51 are also arranged curvilinearly on the support stand 50, and, more precisely, in accordance with the embodiment as illustrated in FIG. 5, in a segment, which corresponds to the ring 40, such that the temperature sensors 51 are provided equidistantly from corresponding energy radiators 41 on ring 40. This ensures that temperature measurement occurs after the same distance travelled by the MDF panel in the transport direction after irradiation (see arrow in FIG. 5).

Since the oscillating motion of the ring 40 can move each of the energy radiators over a certain area of the surface of the MDF plate 8 to be irradiated, they can each be assigned to specific temperature sensors 51, which can gather the temperature measurement in the corresponding areas 58 of the MDF panel 8. These areas 58 are arbitrary, imaginary areas, which are separated from each other in FIG. 5 by dashed lines, and are influenced only by the temperature sensors and/or energy radiators employed.

The readings from the temperature sensors 51 are forwarded to a control device 52, which subjects the assigned energy radiators 41 to either open-loop or closed loop control on the basis of the temperatures determined for the individual areas 58 of the surface to be irradiated.

Depending on how the randomly selected areas 58 are defined, multiple temperature sensors and/or energy radiators 51 can be formed into groups that return either a uniform reading, for example, an average reading, and/or are uniformly subjected to open-loop or closed-loop control.

However, it is also possible, of course, for individual temperature sensors to be assigned to individual energy radiators 41 according to their sphere of action and to provide open-loop or closed-loop control of an individual energy radiator 41 on the basis of the individual reading.

After passing through the radiation appliance with its short-wave infrared radiators or near-infrared radiators or halogen infrared radiators, the treated MDF panel 8 passes directly into a forced air circulation oven 6 serving as processing station 6 (see FIG. 1), in which, in several zones, for example, three zones, appropriately heated circulating air is forced in, for example, via entry openings 24, from bottom to top (see arrow 27) to suction devices 25.

Since the powder firmly adheres to the surface of the MDF panel 8 as a result of the upstream treatment in radiation appliance 21, it is possible to set a very high forced air circulation speed, for example in the range greater than 1 m/s, preferably greater than or equal to 2 m/s, especially greater than or equal to 5 m/s, such that a constant temperature profile can be set over a large distance.

After processing station 6 with its hardening and post-hardening section in the form of a forced air circulation oven 6, a further radiation appliance 21, especially with UV radiators, may be provided. Alternatively, corresponding UV curing in the form of a radiation device equipped with UV radiators can be provided instead of the forced air circulation oven 6 or be integrated into it.

Through the inventive method, as represented in the embodiment, highly uniform powder coatings can be produced on MDF panels, without damage occurring to the MDF panel. This applies not only to wood fiber materials, such as MDF panels, which have been illustrated here by way of example, but in general with regard to heat-sensitive substrates, especially, timber-derived products in general.

In the case of these substrates, it is only necessary to ensure a minimum level of conductivity in order that electrostatic powder-coating may be performed. To this end, MDF panels should preferably have a residual moisture content of between 7 and 7.8 wt %, which can be achieved, for example, by storage in climate chambers and the like. The resistance in this regard has a value of approximately 10¹¹ Ω. Furthermore, it has proved to be advantageous for the MDF panels to have a density of approx. 800 kg/m³ +/−20 kg/m³.

For other materials, the conductivity may be obtained, for example, by corresponding additives or by conductive primer coatings.

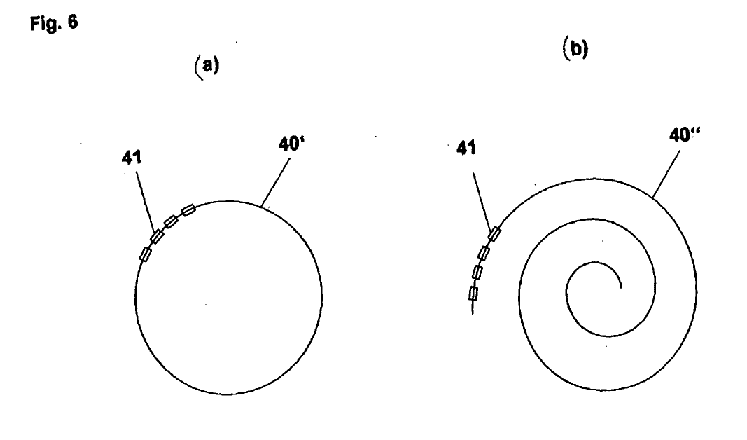

FIGS. 6 (a) and (b) show two other alternatives of the embodiment of an inventive radiation appliance 21, wherein, in FIG. 6 (a), the ring 40′ has an oval shape, wherein the energy radiators 41 are arranged along the oval in similar manner, as shown in the embodiment of FIGS. 2 to 5. Accordingly, only a few energy radiators 41 are shown in FIG. 6 (a).

In similar fashion, FIG. 6 (b) shows a spiral 40″, which also can be used instead of the circular ring 40 in the radiation appliance 21. Here, too, as in FIG. 5 and FIG. 6 (a), a few energy radiators are shown along the spiral 40″, instead of all of them. Again, these energy radiators, as in the embodiments of FIGS. 2 to 5, can be similarly arranged so as to tilt or swivel at spiral 40″.

Although the invention has been described in connection with a preferred embodiment, it is obvious to a person skilled in the art that modifications are possible without departing from the protective scope of the attached claims. Especially, different combinations of individual features and the omission of individual, described features are possible.

1-25. (canceled)

26. A radiation appliance for rapid heating of an irradiation surface of an object moved past a heating device during powder coating, comprising:
several energy radiators distributed across the irradiation surface, which are movably arranged on at least one movable carrier, wherein at least one contact-less measuring temperature sensor that can measure a temperature of the object in at least one area of the irradiation surface of the object and a control unit are provided, which are formed such that the control unit can record a measured temperature of the at least one temperature sensor and controls at least one of the energy radiators, which is assigned to an area of the irradiation surface whose temperature is being measured.

27. The radiation appliance in accordance with claim 26, wherein the control unit is formed as a closed-loop control unit, which automatically sets the temperature in at least one area of the irradiation surface to a predetermined temperature or to a given temperature interval.

28. The radiation appliance in accordance with claim 26, wherein the at least one temperature sensor is formed such that it can determine only the temperature in a localized area of the surface of the object to be irradiated.

29. The radiation appliance in accordance with claim 26, wherein the irradiation surface is subdivided into a plurality of imaginary areas, with one or more temperature sensors being provided for each imaginary area.

30. The radiation appliance in accordance with claim 26, wherein several temperature sensors are grouped together, and wherein corresponding groups uniformly determine readings for an area of the surface.

31. The radiation appliance in accordance with claim 26, wherein several energy radiators are grouped together, wherein corresponding groups are subjected to at least one of open-loop and closed-loop control by the control unit.

32. The radiation appliance in accordance with claim 26, wherein a plurality of areas for the temperature measurement of the irradiation surface are arranged beside or above each other at right angles to a transport direction of the irradiation surface.

33. The radiation appliance in accordance with claim 26, wherein the at least one temperature sensor comprises a plurality of temperature sensors spaced equidistantly from the pertinent energy radiators.

34. The radiation appliance in accordance with claim 26, wherein the at least one temperature sensor comprises a plurality of temperature sensors arranged on a section of one of the group comprising a circular path, a section of an ellipse and a section of an oval.

35. The radiation appliance in accordance with claim 26, wherein the at least one temperature sensor comprises a plurality of temperature sensors provided on opposing and facing sides of the radiation appliance which enclose between them a transport path for the object.

36. The radiation appliance in accordance with claim 26, wherein the at least one temperature sensor comprises a plurality of temperature sensors arranged after the energy radiators in a direction of transport.

37. The radiation appliance in accordance with claim 26, wherein the at least one temperature sensor comprises a plurality of temperature sensors comprising infrared sensors.

38. The radiation appliance in accordance with claim 26, wherein radiant power of the energy radiators may be infinitely variable adjustable by the control unit.

39. The radiation appliance in accordance with claim 26, wherein at least one of the control unit and the at least one temperature sensor are configured such that determination of readings can be automatically adjusted to at least one of emission values and color of the irradiation surface.

40. The radiation appliance in accordance with claim 26, wherein several energy radiators are arranged along an oval or in a spiral.

41. A radiation appliance for rapid heating of an irradiation surface of an object moved past a heating device during powder coating, comprising several energy radiators distributed across the irradiation surface, which are movably arranged on at least one movable carrier, wherein the energy radiators are arranged along an oval or in a spiral.

42. The radiation appliance in accordance with claim 26, wherein the energy-radiators are selected from the group comprising heat radiators, infrared (IR) radiators, short- and medium-wave IR radiators, near-infrared (NIR) radiators, halogen infrared radiators and UV radiators.

43. A method for powder coating of wooden objects using an arrangement comprising a powder-coating station, a first radiation appliance, and a section for hardening or crosslinking the powder comprising at least one of a forced air circulation oven and a second radiation appliance, wherein the first radiation appliance is arranged between the powder-coating station and the section for hardening or crosslinking the powder and the second radiation appliance is arranged in the section for hardening or crosslinking the powder, wherein a moisture content of the wooden objects to be treated is adjusted to 7 to 7.8 wt. % water.

44. The method in accordance with claim 43, wherein an air speed of more than 5 m/s is set in the forced air circulation oven.

45. The method in accordance with claim 43, wherein the powder is applied electrostatically with a leakage current strength in a range from 1 to 10 μA.

46. The method in accordance with claim 43, wherein a surface temperature of the object during irradiation of the powder by the first radiation appliance is greater than 110° C. and a core temperature remains below 100° C.

47. The method in accordance with claim 43, wherein, during hardening or crosslinking, the surface temperature of the object is kept above 110° C.

48. The method in accordance with claim 43, wherein, during hardening or crosslinking, the core temperature of the object is kept below 100° C.

49. An arrangement for powder coating objects comprising a powder-coating station, a first radiation appliance, and a section for hardening or crosslinking the powder comprising at least one of a forced air circulation oven and a second radiation appliance, wherein the first radiation appliance is arranged between the powder-coating station and section for hardening or crosslinking the powder and the second radiation appliance is arranged in the section for hardening or crosslinking the powder, and wherein the arrangement is adapted for performing powder coating of wooden objects, wherein a moisture content of the wooden objects to be treated is adjusted to 7 to 7.8 wt. % water.

50. The arrangement in accordance with claim 49, wherein a climate chamber is provided upstream, in which the objects are stored for a certain period of time at temperatures between 10° C. and 40° C. and a relative humidity of 30% to 50%, in order that the necessary moisture content in the wooden objects may be obtained.
